(19) United States
(12) Patent Application Publication
(10) Pub. No.: US 2025/0128401 A1
(43) Pub. Date: Apr. 24, 2025

(54) EXOSKELETON DEVICE AND METHOD

(71) Applicant: FESTOOL GMBH, Wendlingen (DE)

(72) Inventors: Victor PETERS, Stuttgart (DE); Björn HIPP, Hamburg (DE); Robert WEIDNER, Bohlsen (DE); Dominic Richard ENDER, Nürtingen (DE); Stefan BOZLER, Aichtal (DE); Bernward OTTEN, Hamburg (DE)

(21) Appl. No.: 18/683,207

(22) PCT Filed: Aug. 12, 2022
(86) PCT No.: PCT/EP2022/072717

§ 371 Date: Feb. 12, 2024

(30) Foreign Application Priority Data
Aug. 13, 2021 (DE) 10 2021 208 899.6

(51) Int. Cl. B25J 9/00; A61H 3/00

(52) U.S. Cl. CPC B25J 9/0006; A61H 3/00; A61H 2003/007

(57) ABSTRACT

An exoskeleton device including an exoskeleton having: a base section for attachment to a body section, a support section movably coupled to the base section for supporting a body part of the human body, and an actuator device acting on the support section for providing a support force for the body part. The exoskeleton device further includes a control device which has at least two manually and/or automatically selectable presets, each of which has at least one preset characteristic which defines a support force specification as a function of at least one input variable. The at least two presets differ in their preset characteristics, and the control device is configured to determine the support force specification as a function of the input variable using a preset selected from the at least two presets and to set the support force on the basis of the support force specification.

The invention relates to an exoskeleton device comprising: an exoskeleton having: a base section for attachment to a body section, in particular the torso, of the human body, a support section movably coupled to the base section for supporting a body part, preferably a limb, in particular an arm, of the human body, and an actuator device, in particular a pneumatic actuator device, acting on the support section for providing a support force for the body part, in particular the limb.

An exoskeleton is a device worn on the body that supports the musculoskeletal system in certain postures and movements.

Exoskeletons are known from WO2019072444A2, WO2014195373A1 and EP2754538A1.

One object of the invention is to provide an exoskeleton device with which better support can be achieved

The object is solved by an exoskeleton device according to claim 1.

The exoskeleton device comprises a control device which has at least two manually and/or automatically selectable presets, each of which has at least one preset characteristic which defines a support force specification as a function of at least one input variable, in particular a position of the support section, in particular relative to the base section. The at least two presets differ in their preset characteristics. Using a preset selected from the at least two presets, the control device is configured to determine the support force specification as a function of the input variable and to set the support force on the basis of the support force specification.

The preset can thus be used to define the dependency of the support force specification (and therefore the support force) on the input variable. This makes it possible to provide a preset adapted to the respective work scenario for different work scenarios. When the work scenario changes, the preset can be changed accordingly, in particular manually and/or automatically. By providing presets that differ in their preset characteristics, it is therefore possible to achieve better support, in particular support that is better adapted to the respective work scenario.

Advantageous further developments are the subject of the subclaims.

The invention further relates to a method according to claim 18.

Further exemplary details and exemplary embodiments are explained below with reference to the figures. Thereby shows

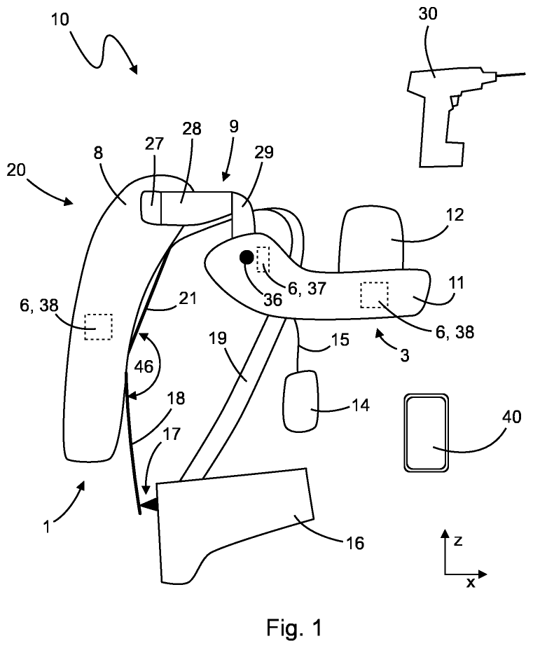

FIG. 1 a schematic side view of an exoskeleton device,

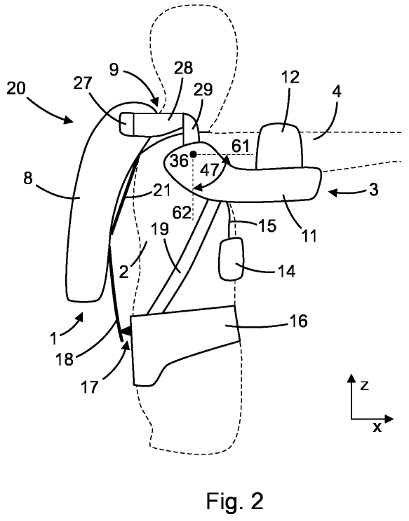

FIG. 2 a schematic side view of an exoskeleton worn by a user,

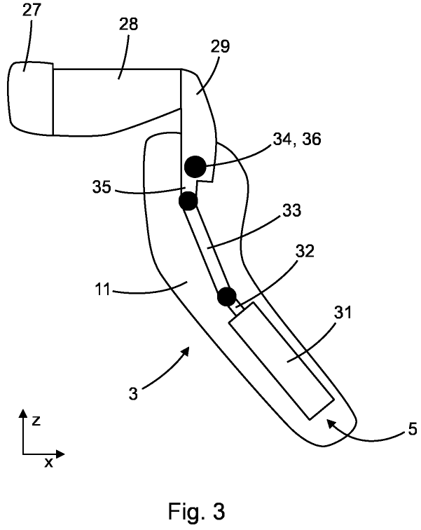

FIG. 3 a schematic detailed view of a support section of the exoskeleton,

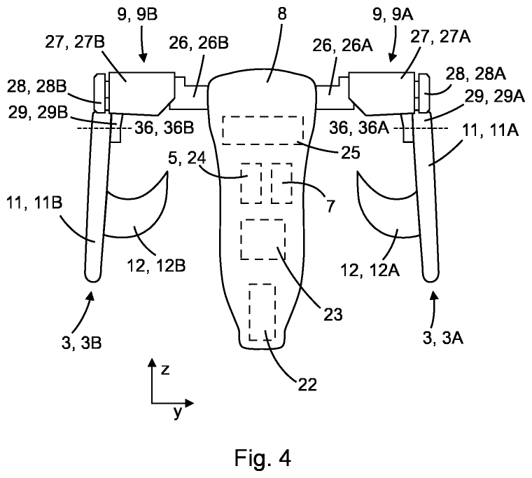

FIG. 4 a schematic rear view of the exoskeleton,

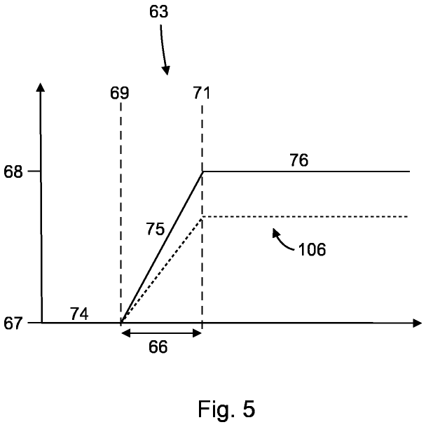

FIG. 5 a characteristic curve representation of an increase interval characteristic,

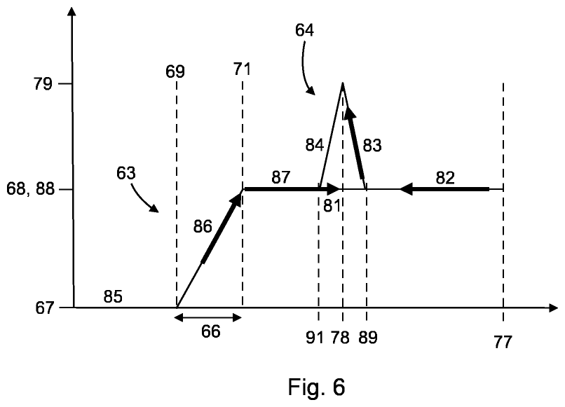

FIG. 6 a characteristic curve representation of a rest position characteristic and

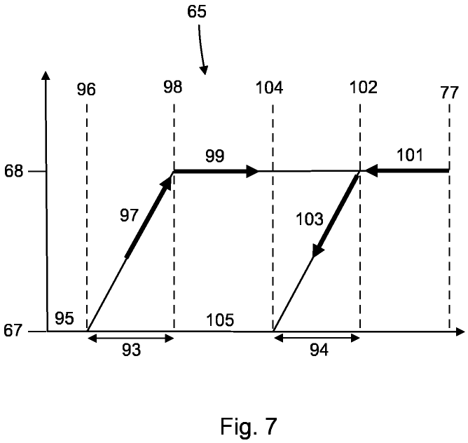

FIG. 7 a characteristic curve representation of a dynamic characteristic.

In the following explanations, reference is made to the spatial directions x-direction, y-direction and z-direction, which are drawn in the figures and are aligned orthogonally to each other. The z-direction can also be referred to as the vertical direction, the x-direction as the depth direction and the y-direction as the width direction.

FIG. 1 shows a schematic representation of an exoskeleton device 10 comprising an exoskeleton 20 and optionally a tool 30 and/or a mobile device 40. The exoskeleton 20 can also be provided on its own. The tool 30 and/or the mobile device 40 are exemplarily provided separately from the exoskeleton 20, i.e. in particular not mechanically connected to the exoskeleton 20. The tool 30 is, for example, a power tool, in particular a cordless screwdriver and/or a drill and/or a grinder. The mobile device 40 is preferably a smartphone or a tablet. Optionally, the exoskeleton 20 is configured to communicate with the tool 30 and/or the mobile device 40, in particular wirelessly.

As an example, the exoskeleton 20 is aligned in an upright orientation with its vertical axis (which in particular runs parallel to a base section axis 62) parallel to the z-direction. In particular, the exoskeleton 20 is aligned in the upright orientation with its sagittal axis parallel to the x-direction. In a state in which the user has put on the exoskeleton 20, the sagittal axis of the exoskeleton 20 runs parallel to the sagittal axis of the user, i.e. in particular parallel to a direction from the rear—i.e. in particular the back of the user—to the front—i.e. in particular the chest of the user. The horizontal axis of the exoskeleton 20 runs in particular in the width direction of the exoskeleton 20 and/or parallel to the y-direction. In a state in which the user has put on the exoskeleton 20, the horizontal axis of the exoskeleton 20 runs parallel to the horizontal axis of the user, i.e. in particular parallel to a direction from a first shoulder of the user to a second shoulder of the user. The vertical axis of the exoskeleton 20, the sagittal axis of the exoskeleton 20 and the horizontal axis of the exoskeleton 20 are aligned orthogonally to each other.

The exoskeleton device 10 is designed in particular for manual and/or industrial use. Preferably, the exoskeleton device 10 is not designed for medical and/or therapeutic use.

The exoskeleton 20 is an active exoskeleton and in particular has an internal energy source from which the energy for the support force is provided. In particular, the exoskeleton 20 is an active exoskeleton for actively supporting the user's shoulder joint.

The exoskeleton 20 comprises a base section 1 for attachment to a body section of a human body of a user. By way of example, the base section 1 serves to be attached to the torso 2 of the human body.

The base section 1 comprises a main section and a textile carrying system, which is in particular detachably attached to the main section. By way of example, the main section serves to be worn on the back of the human body by means of the textile carrying system, in particular in a backpack-like manner. The main section comprises a back part 8, which is in particular elongated and which is expediently aligned with its longitudinal axis vertically and/or in the longitudinal direction of the user's back. For example, the longitudinal direction of the back part 8 extends along the longitudinal direction of the back. The main section further comprises a force transmission element 18, which is in particular strip-shaped and/or rigid and extends downwards from the back part 8 to a pelvic strap 16 in order to mechanically couple the back part 8 to the pelvic strap 16. The force transmission element 18 is expediently used to transmit a reaction force, which is transmitted from a support section 3 to the back part 8, further to the pelvic strap 16. As an example, the back part 8 is tubular and/or backpack-shaped. The back part 8 is in particular rigid. In particular, the back part 8 comprises an expediently rigid back part housing, which is made, for example, from an in particular rigid plastic and/or as a hard shell. The back part 8 expediently serves to transmit a force from the support section 3 to the force transmission element 18 and/or to accommodate components for controlling the support force.

The support section 3 can expediently be referred to as an arm actuator.

The force transmission element 18 is exemplarily sword-shaped and can also be referred to as a sword. Expediently, the force transmission element 18 is designed to be adjustable relative to the back part 8, in particular in order to change the vertical extent of the main section and/or a force transmission element angle 46 between the force transmission element 18 and the back part 8 facing the user's back. Expediently, the force transmission element 18 is mounted for translational and/or rotational movement relative to the back part 8 and, in particular, can be moved into various translational and/or rotational positions relative to the back part 8 and, in particular, can be locked. The translational movement is in particular vertical. The rotational movement is expediently performed about an adjustment axis aligned parallel to the y-direction.

The textile carrying system comprises, by way of example, the pelvic strap 16 and/or at least one, preferably two, shoulder straps 19. The pelvic strap 16 expediently forms a loop so that, when worn, it surrounds the torso 2, in particular the hips, of the user. Each shoulder strap 19 extends exemplarily from the main section, in particular from the back part 8, to the pelvic strap 16, expediently over a respective shoulder of the user when the exoskeleton 20 is worn.

The exoskeleton 20 further comprises, by way of example, a force transmission element joint 17, via which the force transmission element 18 is attached to the pelvic strap 16. The force transmission element joint 17 is designed, for example, as a ball joint and can be referred to as a sacral joint. When the exoskeleton 20 is worn, the force transmission element joint 17 is arranged in the lower back region of the user, in particular centered in the width direction.

By way of example, the textile carrying system also comprises a back net 21, which is arranged on the side of the back part 8 facing the user's back. When the exoskeleton 20 is worn, the back net 21 lies against the user's back, in particular at least partially and/or in the upper back region.

The exoskeleton 20 further comprises the support section 3 movably coupled to the base section 1 for supporting a body part, preferably a limb, in particular an arm 4, of the human body of the user. In particular, the support section 3 is designed to be attached to the body part, preferably the limb, in particular the arm 4, of the user. The support section 3 comprises, by way of example, an in particular rigid arm part 11 and an arm attachment 12 arranged on the arm part 11, which is designed, by way of example, as an arm shell. The arm part 11 is exemplarily elongated and, when worn, is aligned with its longitudinal axis in the direction of the longitudinal axis of the user's arm. As an example, the arm part 11 extends from the shoulder of the user to the elbow area of the user. The exoskeleton 20, in particular the arm part 11, ends at the elbow area of the user. The arm attachment 12 is used in particular to attach the support section 3 to the arm 4, in particular the upper arm, of the user. In particular, the arm shell surrounds the upper arm of the user, in particular at least partially, so that the upper arm can be held in the arm shell with a strap. The user's forearm is expediently not attached to the exoskeleton 20.

The body part is preferably a limb of the human body. For example, the body part is an arm of the human body. Furthermore, the body part may be the back of the human body. In this case, the base section expediently serves for attachment to a leg of the human body; i.e. the body section (to which the base section is to be attached) may be, for example, a leg in the case where the body part is the back.

As an example, the support section 3 is mounted so that it can pivot about a horizontal pivot axis relative to the base section 1, in particular relative to the back part 8. As an example, the support section 3 is mounted directly on a shoulder part 29. The horizontal pivot axis can also be referred to as the lifting axis 36. When the exoskeleton 20 is worn, the lifting axis 36 is located in the area of the user's shoulder. In particular, the exoskeleton 20 is designed to support the user's shoulder joint with the support section 3. When the exoskeleton 20 is worn, the user can perform a lifting movement with his arm 4 supported by the support section 3 by pivoting the support section 3 about the lifting axis 36. In particular, the lifting axis 36 can be aligned in the y-direction. Expediently, the lifting axis 36 always lies in a horizontal plane, for example an x-y plane. In particular, a horizontal plane is to be understood as an exactly horizontal plane and/or a plane that is tilted by a maximum of 10 degrees, 7 degrees or 5 degrees relative to a horizon.

The pivot angle 47 of the support section 3 about the lifting axis 36 relative to the base section 1 should also be referred to as the lifting angle. The pivot angle 47 has a reference value, in particular a minimum value, when the support section 3 is oriented downwards (in the case of a vertically oriented exoskeleton 20) and increases continuously up to a maximum value when the support section 3 is pivoted upwards. The minimum value is in particular a minimum value in terms of amount, for example zero.

As an example, the pivot angle 47 is defined as an angle between a support section axis 61 and a base section axis 62. The support section axis 61 extends in the longitudinal direction of the support section 3. Exemplarily, the support section axis 61 extends from the lifting axis 36 in the direction of the arm attachment 12. In a state in which the user has put on the exoskeleton 20, the support section axis 61 expediently extends parallel to an upper arm axis of the arm 4 supported by the support section 3. The base section axis 62 expediently represents a vertical axis of the base section 1 and extends vertically downwards, in particular in a vertical orientation of the base section 1, for example in a state in which the user has put on the exoskeleton 20 and is standing upright. As an example, the pivot angle 47 lies in a z-x plane, for example when the user is standing upright and the arms are lifted fowards.

The exoskeleton 20 comprises, by way of example, a shoulder joint arrangement 9, via which the support section 3 is attached to the base section 1, in particular the back part 8. The shoulder joint arrangement 9 expediently comprises a joint chain with one or more pivot bearings for defining one or more vertical axes of rotation. By means of the joint chain, it is expediently possible to pivot the support section 3 relative to the base section 1, in particular relative to the back part 8, in a preferably horizontal pivot plane, for example about a virtual vertical axis of rotation. In particular, the joint chain enables the user to pivot his arm 4, which is supported by the support section 3, about a vertical axis of rotation running through the user's shoulder, whereby the support section 3 is moved along with the arm 4. As an example, the joint chain is designed to be passive, so that the exoskeleton 20 does not provide any active support force in the direction of the horizontal pivot movement when the arm is pivoted in the preferably horizontal pivot plane.

The shoulder joint arrangement 9 is expediently arranged and/or designed in such a way that it defines a free space which, when the exoskeleton 20 is worn, is located above the shoulder of the user wearing the exoskeleton 20, so that the user can align his arm, which is supported by the support section 3, vertically upwards through the free space past the shoulder joint arrangement 9.

By way of example, the shoulder joint arrangement 9 comprises an inner shoulder joint section 27, which is mounted so as to be pivotable about a first vertical axis of rotation relative to the base section 1, in particular to the back part 8, by means of a first pivot bearing of the shoulder joint arrangement 9. By way of example, the shoulder joint arrangement 9 further comprises an outer shoulder joint section 28, which is mounted so as to be pivotable about a second vertical axis of rotation relative to the inner shoulder joint section 27 by means of a second pivot bearing of the shoulder joint arrangement 9. By way of example, the shoulder joint arrangement 9 further comprises a shoulder part 29 which is mounted so as to be pivotable about a third vertical axis of rotation relative to the outer shoulder joint section 28 by means of a third pivot bearing of the shoulder joint arrangement 9. Preferably, the inner shoulder joint section 27, the outer shoulder joint section 28 and the shoulder part 29 in the shoulder joint arrangement 9 are kinematically coupled to one another as the joint chain in such a way that the pivot angle of the inner shoulder joint section 27 relative to the base section 1 determines the pivot angle of the outer shoulder joint section 28 relative to the inner shoulder joint section 27 and/or the pivot angle of the shoulder part 29 relative to the outer shoulder joint section 28.

FIG. 3 shows a schematic detailed view of the support section 3, with components arranged within the arm part visibly shown. The arm part 11 expediently comprises an arm part housing, which is in particular rigid and made of plastic, for example.

The exoskeleton 20 comprises an actuator device 5 acting on the support section 3 to provide a support force for the body part, preferably the limb, exemplarily for the user's arm. By way of example, the actuator device 5 is arranged at least partially in the arm part 11.

The actuator device 5 is an active actuator device. Expediently, the exoskeleton 20 provides the support force by means of the actuator device 5 with a force component acting upwards in the direction of the pivoting movement about the lifting axis 36, which pushes the user's arm 4 upwards in the direction of the pivoting movement.

Preferably, the actuator device 5 comprises an actuator unit with an actuator member 32. The actuator unit can apply an actuator force to the actuator member 32 in order to provide the support force. The actuator member 32 is coupled to an eccentric section 35 arranged eccentrically to the lifting axis 36. The eccentric section 35 is part of the shoulder part 29, for example. By coupling the actuator member 32 to the eccentric section 35, the actuator force provides a torque of the support section 3 about the lifting axis 36 relative to the base section 1 and/or the shoulder part 29. Due to this torque, the support section 3 presses against the body part, preferably the limb, in particular the arm 4, of the user, in particular upwards, and thus provides the support force acting on the body part, preferably the limb, in particular the arm 4, of the user.

As an example, the actuator device 5 has a coupling element 33, in particular designed as a push rod, via which the actuator member 32 is coupled to the eccentric section 35.

Preferably, the actuator device 5 is a pneumatic actuator device and the actuator unit is expediently designed as a pneumatic drive cylinder 31. The actuator member 32 is the piston rod of the drive cylinder 31.

Alternatively, the actuator device may not be designed as a pneumatic actuator device. For example, the actuator device can be designed as a hydraulic and/or electric actuator device and, expediently, comprise a hydraulic drive unit and/or an electric drive unit as the actuator unit.

The drive cylinder 31, the actuator member 32 and/or the coupling element 33 are preferably arranged in the arm part housing.

The exoskeleton 20 expediently comprises a lifting pivot bearing 34, which provides the lifting axis 36. As an example, the support section 3 is attached to the shoulder joint arrangement 9 via the lifting pivot bearing 34.

FIG. 4 shows a rear view of the exoskeleton 20, whereby the textile support system and the force transmission element 18 are not shown.

The exoskeleton 20 comprises, by way of example, one or more batteries 22, a compressor 23, a valve unit 24 and/or a compressed air tank 25, which are expediently part of the base section 1 and are arranged in particular in the back part housing.

By way of example, the rechargeable battery 22 is arranged at the bottom of the back part 8 and, in particular, is inserted into a rechargeable battery holder of the back part 8 from below. Expediently, the compressed air tank 25 is arranged in an upper region in the back part 8, exemplarily (in particular in the longitudinal direction of the back part 8 and/or vertical direction) above the valve unit 24, the control device 7, the compressor 23 and/or the rechargeable battery 22. The valve unit 24 and/or the control device 7 is (in particular in the longitudinal direction of the back part 8 and/or vertical direction) expediently arranged above the compressor and/or above the rechargeable battery 22. The compressor 23 is arranged (in particular in the longitudinal direction of the back part 8 and/or vertical direction) above the battery 22.

The battery 22 serves as an electrical power supply for the exoskeleton 20, in particular for the compressor 23, the valve unit 24, a sensor device 6 and/or a control device 7.

The compressor 23 is designed to compress air in order to generate compressed air. The compressed air tank 25 is designed to store compressed air—in particular the compressed air generated by the compressor 23.

The valve unit 24 expediently comprises one or more electrically operable valves and is designed in particular to influence a pneumatic connection from the compressed air tank 25 to a pressure chamber of the pneumatic drive cylinder 31, in particular to selectively establish and/or block the pneumatic connection. Expediently, the valve unit 24 is further designed to influence a pneumatic connection from the compressed air tank 25 to the environment of the exoskeleton 20 and/or a pneumatic connection from the pressure chamber of the drive cylinder 31 to the environment of the exoskeleton 20, in particular to selectively establish and/or block the pneumatic connection. The valve unit 24 is expediently part of the actuator device 5.

The exoskeleton 20 further comprises a sensor device 6. As an example, the sensor device 6 comprises an angle sensor 37 for detecting the angle of the support section 3 relative to the base section 1, in particular the arm part 11 relative to the shoulder part 29. This angle should also be referred to as the pivot angle 47 or the lifting angle. The angle sensor 37 is used in particular to detect the angle of the support section 3 about the lifting axis 36. The angle sensor 37 is designed, for example, as an incremental encoder and is arranged in particular on the lifting pivot bearing 34, in particular in the arm part 11 and/or in the shoulder part 29.

Preferably, the sensor device 6 further comprises at least one pressure sensor for detecting the pressure prevailing in the pressure chamber of the drive cylinder 31 and/or the pressure prevailing in the compressed air tank 25. The at least one pressure sensor is expediently arranged in the back part 8 and/or in the arm part 11.

The exoskeleton device 10, in particular the exoskeleton 20, expediently comprises a control device 7, which for example comprises a microcontroller or is designed as a microcontroller. The control device 7 is used in particular to control the actuator device 5, in particular the valve unit 24, in order to control the provision of the support force. Furthermore, the control device 7 is used to read out the sensor device 6, in particular to read out data recorded by the sensor device 6 and/or to communicate with the tool 30 and/or the mobile device 40. Preferably, the control device 7 is designed to adjust the pressure prevailing in the pressure chamber of the drive cylinder 31 by actuating the valve unit 24, in particular to closed-loop control the pressure, for example taking into account a pressure value recorded by means of the pressure sensor. In particular, the control device 7 is designed to increase the pressure prevailing in the pressure chamber by actuating the valve unit 24 in order to increase the support force and/or to reduce the pressure prevailing in the pressure chamber by actuating the valve unit 24 in order to reduce the support force.

According to a preferred embodiment, the control device 7 is designed to adjust the support force on the basis of the pivot angle 47 of the support section 3 detected in particular by means of the angle sensor 37. Expediently, the user can use his muscle strength to change the pivot angle 47 of the support section 3 by pivoting his arm 4, thereby influencing in particular the provision of the support force. In particular, the support force is low enough so that the user can change the pivot angle 47 of the support section 3 by pivoting his arm 4 using his muscle strength. The support force is limited, for example, by the design of the pneumatic system, in particular the compressor, and/or by the control device 7.

The control device 7 is preferably part of the exoskeleton 20 and is exemplarily arranged in the base section 1, in particular in the back part 8. Optionally, the control device 7 can be at least partially implemented in the mobile device 40.

As an example, the exoskeleton 20 comprises an operating element 14, which is expediently attached to the base section 1 via an operating element cable 15. The user can control the exoskeleton 20 via the operating element 14 and, in particular, activate, deactivate and/or set the support force to one of several possible force values greater than zero.

As an example, the exoskeleton 20 further has a connecting element 26, via which the shoulder joint arrangement 9 is attached to the base section 1, in particular the back part 8. The connecting element 26 is exemplarily designed as a pull-out element. The connecting element 26 is expediently adjustable in its position relative to the base section 1, in particular relative to the back part 8, in order to be able to adapt the position of the shoulder joint arrangement 9 and the support section 3 to the shoulder width of the user. In particular, the position of the connecting element 26 can be adjusted by pushing or pulling the connecting element 26 in or out of the back part 8.

By way of example, the exoskeleton 20 has a first support section 3A, a first shoulder joint arrangement 9A and a first connecting element 26A, as well as a second support section 3B, a second shoulder joint arrangement 9B and a second connecting element 26B. The components whose reference signs are provided with the suffix “A” or “B” are expediently each designed in correspondence with the components provided with the same reference sign number but without the suffix “A” or “B”, for example identical or mirror-symmetrical, so that the explanations in this regard apply in correspondence.

The first support section 3A, the first shoulder joint arrangement 9A and the first connecting element 26A are arranged on a first, exemplarily the right, side (in width direction) of the base section 1, and serve to support a first, in particular the right, arm of the user.

The second support section 3B, the second shoulder joint arrangement 9B and the second connecting element 26B are arranged on a second, exemplarily the left, side (in width direction) of the base section 1 and serve to support a second, in particular the left, arm of the user.

The first support section 3A comprises a first arm part 11A, a first arm attachment 12A and/or a first actuator unit, in particular a first drive cylinder.

The second support section 3A comprises a second arm part 11B, a second arm attachment 12B and/or a second actuator unit, in particular a second drive cylinder.

Preferably, the control device 7 is designed to set a first support force for the first support section 3A by means of the first actuator unit and to set a second support force for the second support section 3B by means of the second actuator unit, which second support force is expediently different from the first support force.

The first shoulder joint arrangement 9A comprises a first inner shoulder joint section 27A, a first outer shoulder joint section 28A and a first shoulder part 29A. The second shoulder joint arrangement 9B comprises a second inner shoulder joint section 27B, a second outer shoulder joint section 28B and a second shoulder part 29B.

The first support section 3A is pivotable about a first horizontal lifting axis 36A relative to the base section 1 and the second support section 3B is pivotable about a second horizontal lifting axis 36B relative to the base section 1.

In FIG. 2, the exoskeleton 20 is shown in a state in which it is worn by a user, in particular worn as intended. By the formulation that the user is wearing the exoskeleton 20, in particular wearing it as intended, it is meant that the user has put on the exoskeleton, i.e. put it on, by way of example in that the user is wearing the back part 8 on his back like a backpack, has put on the pelvic strap 16 around his hips, the shoulder strap or shoulder straps 19 run over the shoulder or shoulders of the user and/or one or both arms of the user are attached to the respective support section 3 with a respective arm attachment 12.

By way of example, the exoskeleton 20 is designed to support the user during a lifting movement of a respective arm, i.e. during an upwardly directed pivoting of the respective support section 3 about a respective lifting axis 36, with a respective support force acting in particular upwards. Furthermore, the exoskeleton 20 is expediently designed to support or counteract the user during a lowering movement, i.e. during a downward pivoting of the respective support section 3 about a respective lifting axis 36, with a respective support force acting in particular upwards, or to deactivate or reduce the respective support force during the lowering movement.

The control device 7 has at least two manually and/or automatically selectable presets, each of which has at least one preset characteristic that defines a support force specification as a function of at least one input variable, in particular a position of the support section 3. The at least two presets differ in their preset characteristics.

The presets can also be referred to as application profiles and the preset characteristics can also be referred to as application profile characteristics. The presets are preferably stored in the control device 7.

In particular, the control device 7 has at least a first preset with a first preset characteristic and a second preset with a second preset characteristic. The first preset characteristic and the second preset characteristic each define the support force specification as a function of the at least one input variable. The first preset characteristic differs from the second preset characteristic.

Each preset characteristic represents a mapping of the at least one input variable to the support force specification. For example, each preset characteristic comprises a characteristic curve that defines the support force specification as a function of the at least one input variable. For example, each preset characteristic defines at least one respective value of the support force specification for each value of the value range of the input variable. In particular, the characteristic curve varies over the value range of the input variable. The characteristic curve can also be referred to as a support force characteristic curve. For example, each support force characteristic curve is a support force curve that varies over the value range of the input variable. The support force characteristic curve can, for example, be part of a support force characteristic map of the respective preset characteristic.

Preferably, the first preset characteristic and/or the second preset characteristic define a change in the support force specification as a function of the input variable, so that the support force specification is expediently not constant over the entire value range of the input variable.

The at least one input variable preferably comprises the position of the support section 3, the position of the base section 1 and/or a tool signal received from the tool 30. Furthermore, the at least one input variable may comprise a direction of movement of the support section 3 and/or a previous position, for example a previous pivot angle 47, of the support section 3. Optionally, the input variable may further comprise a speed, in particular a rotational speed, of the support section 3.

The position of the support section 3 is in particular the orientation of the support section 3 relative to the base section 1 or relative to gravity. For example, the position of the support section 3 is the pivot angle 47, in particular the current pivot angle 47. Preferably, each preset characteristic maps the pivot angle 47 to the support force specification. The position of the base section 1 is in particular the orientation of the base section 1 relative to gravity and is detected, for example, by the exoskeleton device 10 with a position sensor 38, in particular an acceleration sensor. For example, a respective position sensor 38, in particular an acceleration sensor, is present on the base section 1 and/or on the support section 3. The acceleration sensor is expediently a multi-axis acceleration sensor in each case.

According to one possible embodiment, one or more preset characteristics each define a mapping of several input variables to the support force specification. For example, one or more preset characteristics each define a mapping of the pivot angle 47, the position of the base section 1 and/or the tool signal to the support force specification. Expediently, these one or more preset characteristics comprise a respective support force characteristic map that maps the multiple input variables to the support force specification.

The at least two presets differ in their preset characteristics. For example, the first preset characteristic is a different type of preset characteristic than the second preset characteristic. Further, the first preset characteristic may be the same type of preset characteristic as the second preset characteristic and may differ from the second preset characteristic in one or more configuration parameters that affect the dependency between the at least one input variable and the support force specification. Due to the difference between the first preset characteristic and the second preset characteristic, the first preset maps at least one value, preferably several values, of the at least one input variable to a different value, preferably several different values, of the support force specification than the second preset. For the same input variable, using the first preset therefore expediently results in a different support force specification than when using the second preset.

The control device 7 is configured to use a preset selected from the at least two presets to determine the support force specification as a function of the input variable and to set the support force on the basis of the support force specification. Expediently, a selection is made from the first preset and the second preset—in particular automatically or manually—and the control device 7 uses the selected preset to determine, in particular calculate, the support force specification on the basis of the at least one input variable. One or more non-selected presets are not used to calculate the support force specification. On the basis of the determined support force specification, the control device 7 sets the support force, expediently by controlling the actuator device 5, in particular the valve unit 24.

The support force specification expediently corresponds to the actuator force to be provided and/or the support force to be provided and is preferably identical to or proportional to the actuator force to be provided and/or the support force to be provided. For example, the support force specification corresponds to a pressure to be provided in the pressure chamber of the pneumatic drive cylinder 31. In particular, the support force specification is identical to or proportional to the pressure to be provided in the pressure chamber.

With reference to FIGS. 5 to 7, various exemplary types of preset characteristics will be discussed below, namely an increase interval characteristic 63 (FIG. 5), a rest position characteristic 64 (FIG. 6) and a dynamic characteristic 65 (FIG. 7). In the diagrams in FIGS. 5, 6 and 7, the input variable, in particular the position, preferably the pivot angle 47, of the support section 3 is plotted on the horizontal axis and the support force specification is plotted on the vertical axis.

Preferably, the presets of the control device 7 comprise different preset characteristics, in particular different types of preset characteristics. For example, the first preset and/or the second preset comprises at least one increase interval characteristic 63, a rest position characteristic 64 and/or a dynamic characteristic 65.

Preferably, the at least one preset characteristic comprises an increase interval characteristic 63. FIG. 5 shows a characteristic curve representation of an exemplary increase interval characteristic 63 (as a solid line). The increase interval characteristic 63 defines an increase interval 66 in relation to the input variable, in particular the pivot angle 47, in which increase interval 66 the support force specification increases continuously with increasing input variable. The increase interval 66 is an interval of the input variable. As an example, the increase interval 66 is an angular range of the pivot angle 47. The increase interval 66 extends from a lower increase interval limit 69 to an upper increase interval limit 71. The lower increase interval limit 69 lies, for example, at a pivot angle 47 of less than 90 degrees. The upper increase interval limit 69 lies, for example, at a pivot angle of greater than 90 degrees.

Preferably, the increase interval characteristic 63 defines a predetermined curve shape for the increase of the support force specification in the increase interval 66. As an example, the predetermined curve shape is a linear curve shape. Alternatively, the predetermined curve shape may be curved, for example parabolic or exponentially increasing.

By way of example, the increase interval characteristic 63 defines a substantially constant support force specification above and/or below the increase interval 66, preferably a constant support force specification. For example, the increase interval characteristic 63 below the increase interval 66 defines a first, exemplarily constant, support force specification 67 and above the increase interval 66 a second, exemplarily constant, support force specification 68, which is, for example, greater than the first support force specification 67. The first support force specification 67 is zero, for example. The second support force specification 68 is, for example, greater than zero.

By way of example, the first support force specification 67 is a first support force specification value and the second support force specification 68 is a second support force specification value.

The increase interval characteristic 63 represents an increase interval characteristic curve. In particular, the increase interval characteristic may be a bi-linear characteristic curve. The increase interval characteristic curve comprises a first characteristic curve section 74 which extends to the lower increase interval limit 69, in particular starting from an input variable equal to zero. The first characteristic curve section 74 is expediently constant, in particular equal to zero. The first characteristic curve section 74 defines the first support force specification 67. The increase interval characteristic curve further comprises a second characteristic curve section 75, which expediently adjoins the first characteristic curve section 74 in the direction of the increasing input variable. The second characteristic curve section 75 expediently provides the increase interval 66 and extends from the lower increase interval limit 69 to the upper increase interval limit 71. The second characteristic curve section 75 is expediently monotonically increasing, in particular strictly monotonically increasing, for example linearly increasing. The increase interval characteristic curve further comprises a third characteristic curve section 76, which expediently adjoins the second characteristic curve section 76 in the direction of the increasing input variable. As an example, the third characteristic curve section 76 extends from the upper increase interval limit 71 to a maximum value of the input variable. The third characteristic curve section 76 is exemplarily constant, in particular greater than zero. The third characteristic curve section 76 defines the second support force specification. The characteristic curve sections 74, 75, 76 can also be referred to as increase interval characteristic curve sections.

The length of the increase interval 66, the lower increase interval limit 69, the upper increase interval limit 71, the first support force specification 67 and/or the second support force specification 68 are expediently configuration parameters of the increase interval characteristic.

For example, the user can set the length of the increase interval 66, in particular via the operating element 14 and/or the mobile device 40. The first support force specification 67 and the second support force specification 68 can remain unchanged when setting the length of the increase interval 66, so that the slope of the second characteristic curve section 75 can be set by setting the length of the increase interval 66.

Optionally, a dependency on a speed of the support section 3 can be defined in the increase interval characteristic. For example, a course of the increase interval 66 can be designed to be speed-dependent.

Optionally, transition areas can also be designed differently. For example, transition regions between the first characteristic curve section 74 and the second characteristic curve section 75 and/or between the second characteristic curve section 75 and the third characteristic curve section 78 can be interpolated, for example by means of linear or spline interpolation. Optionally, a binary transition from the first characteristic curve section 74 directly to the third characteristic curve section 76 is also possible, in particular if the length of the increase interval 66 is set to zero.

Preferably, the at least one preset characteristic comprises a rest position characteristic 64. FIG. 6 shows a characteristic curve representation of an exemplary rest position characteristic 64. The rest position characteristic 64 can, for example, be defined between an upper increase interval limit 71 and a switching value 77. The rest position characteristic 64 defines a predetermined position 78, in particular a predetermined pivot angle 47, of the support section 3 as the rest position, in which the support force specification increases (optionally jumps) to a rest position specification value 79 in order to hold the body part, preferably the limb, in particular the arm 4, in the rest position. In the rest position characteristic, the input variable comprises the position, in particular the pivot angle 47, of the support section 3. Preferably, the support force input increases rapidly, sharply and/or disproportionately to the rest position specification value 79, in particular with a greater slope than the increase interval 66.

Optionally, the exoskeleton 20 can be designed to block the support section 3 in the predetermined position 78 (in particular mechanically).

Preferably, the rest position specification value 79 provides a support force that is at least large enough for gravitational compensation so that the user of the exoskeleton device 10 does not have to apply any force to his body part supported by the support section 3, preferably the limb, in particular his arm 4, in the rest position in order to hold the body part, preferably the limb, in particular the arm 4, in the rest position. In particular, the rest position specification value 79 is such that the user does not have to apply any upward force to his arm 4 in order to hold the arm 4 in the rest position. In particular, the rest position specification value 79 is such that the resulting upwardly acting support force on the arm 4 is equal to or greater than the downwardly acting weight force on the support section 3 caused by the arm 4 and/or an object carried by the arm 4, for example the tool 30.

As an example, the rest position specification value 79 is a local maximum of the support force specification, so that the support force specification immediately above and below the rest position is smaller than the rest position specification value. As an example, the rest position specification value 79 is a global maximum of the support force specification.

Expediently, in the rest position characteristic 64, the support force specification further depends on whether the support section 3 is moved in a lifting direction or in a lowering direction, in particular such that the rest position is provided when the support section 3 is moved in the lowering direction and reaches the predetermined position 78 and is not provided when the support section 3 is moved in the lifting direction and reaches the predetermined position 78. The provision of the rest position refers to the in particular sudden increase in the support force specification at the predetermined position 78. The lifting direction is a direction in which the input variable, in particular the pivot angle 47, increases. The lowering direction is a direction in which the input variable, in particular the pivot angle 47, becomes smaller.

Optionally, the provision of the rest position can further depend on whether the input variable, in particular the pivot angle 47, has previously reached a switching value 77, in particular after a movement of the support section 3 in the lifting direction and/or before a movement of the support section 3 in the lowering direction. For example, the rest position is provided if the support section 3 has previously reached the switching value 77, and is not provided if the support section 3 has not previously reached the switching value 77 or if the support section 3 has fallen below the increase section end 91 during a downward movement. As an example, the switching value 77 is above the predetermined position 78.

The rest position characteristic represents a rest position characteristic curve. By way of example, the rest position characteristic curve comprises a first characteristic curve section 81, which by way of example extends beyond the predetermined position 78, in particular up to a maximum value of the input variable and/or up to the switching value 77. By way of example, the first characteristic curve section 81 begins at an upper increase interval limit 71. The first characteristic curve section 81 expediently does not comprise a sudden increase in the support force specification. As an example, the first characteristic curve section 81 is constant, in particular greater than zero. In particular, the first characteristic curve section 81 defines a second support force specification 68. The first characteristic curve section 81 is preferably active when the support section 3 is moved in the lifting direction and/or when the switching value 77 has not yet been reached.

The rest position characteristic curve comprises, by way of example, a second characteristic curve section 82, which expediently extends from the maximum value of the input variable and/or the switching value 77 to the increase section start 89. The second characteristic curve section 82 is exemplarily constant, in particular greater than zero, for example equal to the first characteristic curve section. In particular, the second characteristic curve section 82 defines a third support force specification 88, which is purely by way of example equal to the second support force specification 68. The second characteristic curve section 82 is preferably active when the support section 3 is moved in the lowering direction and/or when the switching value 77 has previously been reached.

The rest position characteristic curve comprises a third characteristic curve section 83 and a fourth characteristic curve section 84, which together form an increase section. The increase section is located at the predetermined position 78 and has, by way of example, the form of a triangular signal or a triangular curve. In particular, the increase section can be pulse-shaped or impulse-shaped. The increase section extends from the increase section start 89 to an increase section end 91. The increase section start 89 is exemplarily above the predetermined position 78 and the increase section end 91 is exemplarily below the predetermined position 78. The increase section start 89 and the increase section end 91 are close to the predetermined position 78.

The third characteristic curve section 83 extends from the increase section start 89 to the predetermined position 78 and reaches the rest position specification value 79 at the predetermined position 78. The third characteristic curve section 83 increases in particular linearly, preferably starting from a support force specification defined by the second characteristic curve section 82 to the rest position specification value 79. The third characteristic curve section 83 is preferably active when the support section 3 is moved in the lowering direction and/or when the switching value 77 has previously been reached. For example, the third characteristic curve section 83 is a rising edge.

The fourth characteristic curve section 84 extends from the predetermined position 78 to the increase section end 91. In particular, the fourth characteristic curve section decreases linearly, preferably starting from the rest position specification value 79 to a support force specification defined by the first characteristic curve section 81 or a support force specification defined by a seventh characteristic curve section 87. The fourth characteristic curve section 84 is preferably active when the support section 3 is moved in the lowering direction and/or when the switching value 77 has previously been reached. For example, the third characteristic curve section 83 is a falling edge.

FIG. 6 also shows a fifth characteristic curve section 85, a sixth characteristic curve section 86 and the seventh characteristic curve section 87. The characteristic curve sections 85, 86, 87 can be part of the rest position characteristic or can form an increase interval characteristic 63. In particular, the fifth characteristic curve section 85 corresponds to the first increase interval characteristic curve section 74, the sixth characteristic curve section 86 corresponds to the second increase interval characteristic curve section 75 and/or the seventh characteristic curve section 87 corresponds to the third increase interval characteristic curve section 76.

The fifth characteristic curve section 85 extends, by way of example, to the lower increase interval limit 69 and is preferably constant, in particular equal to zero, and expediently defines a first support force specification 67. The sixth characteristic curve section 86 extends, by way of example, from the lower increase interval limit 69 to the upper increase interval limit 71 and is monotonically increasing, in particular linearly increasing. The seventh characteristic curve section 87 extends, by way of example, from the upper increase interval limit 71 to the increase section end 91 and is preferably constant, in particular greater than zero, and expediently defines a second support force specification 68. The fifth characteristic curve section 85, sixth characteristic curve section 86 and/or seventh characteristic curve section 87 are active in particular when the support section 3 is moved in the lowering direction and/or when the support section 3 is moved in the lifting direction.

The characteristic curve sections 81, 82, 83, 84, 85, 86, 87 of the rest position characteristic can also be referred to as rest position characteristic curve sections.

Expediently, the predetermined position 78, in particular the pivot angle 47 of the predetermined position 78 and/or the rest position specification value 79 represent configuration parameters of the rest position characteristic. Furthermore, the length of the increase interval 66, the lower increase interval limit 69, the upper increase interval limit 71, the first support force specification 67 and/or the second support force specification 68 can be configuration parameters.

The characteristic curve shown in FIG. 6 can in particular belong to a preset that comprises the increase interval characteristic 63 and the rest position characteristic 64 in combination.

Using the rest position characteristic, it is possible to define, within a defined support interval, a rest point—the rest position—for supporting the arm weight, for example when working with a largely static arm position. In this rest position, the targeted control of the support force allows the user to “put down” one or both arms in order to carry out work with a static arm position. The rest position is characterized by a sharp increase in support force. If the user wants to move the arms downwards, they can apply more downward pressure once to go below the rest position and thus leave the angular range of the rest position, in particular leave the third characteristic curve section 83 in the direction of the seventh characteristic curve section 87. Instead of a triangular course, the increase section can also have a plateau or a different course, for example to influence other properties, e.g. a resting run or resilience.

Preferably, the at least one preset characteristic comprises a dynamic characteristic 65. FIG. 7 shows a characteristic curve representation of an exemplary dynamic characteristic 65.

With the dynamic characteristic 65, the relationship between the support force specification and the input variable, in particular the pivot angle 47, depends on the direction of change of the input variable and/or on reaching at least one predetermined switching value 77 of the input variable. For example, the dynamic characteristic 65 defines a different relationship between the support force specification and the input variable for a movement of the support section 3 in the lifting direction and/or before the switching value 77 is reached than for a movement of the support section 3 in the lowering direction and/or after the switching value 77 is reached.

As an example, the dynamic characteristic defines at least a first change interval 93 and a second change interval 94, in each of which the support force specification changes via the input variable. Preferably, a dependency is defined in the dynamic characteristic 65 such that, depending on the direction of change of the input variable and/or the reaching of the switching value 77, either the first change interval 93 or the second change interval 94 defines the relationship between the support force specification and the input variable. As an example, the first change interval 93 is active when the input variable is increasing and/or before the switching value 77 is reached and is inactive when the input variable is decreasing and/or after the switching value 77 is reached. Furthermore, as an example, the second change interval 94 is inactive when the input variable is increasing and/or before the switching value 77 is reached and is active when the input variable is decreasing and/or after the switching value 77 is reached.

The switching value 77 is, by way of example, above—i.e. at a greater value of the input variable, in particular the pivot angle 47, than the first change interval 93 and/or the second change interval 94.

As an example, the input variable is an angle of the support section. The angle is in particular the pivot angle 47. The first change interval 93 is an increase interval in which the support force input increases continuously as the angle increases. The second change interval 94 is a decrease interval in which the support force input decreases continuously as the angle decreases. As an example, the increase interval ends at a smaller angle than the decrease interval begins. Alternatively, the increase interval ends at a larger angle than the decrease interval begins. By way of example, the dynamic characteristic 65 defines at least one substantially constant, in particular constant, support force specification outside the change intervals. In an exemplary embodiment, the dynamic characteristic defines in each case below the first change interval 93 and/or the second change interval 94 a first support force specification 67, which is in particular constant, in an exemplary embodiment equal to zero. By way of example, the dynamic characteristic defines a second support force specification 68 above the first change interval 93 and/or the second change interval 94, which is in particular constant, in particular greater than the first support force specification, in particular greater than zero.

The dynamic characteristic 65 represents a dynamic characteristic curve. The dynamic characteristic curve preferably comprises a first characteristic curve range, which is active during a lifting movement of the support section 3 from an initial value of the input variable until the switching value 77 is reached and is inactive during a lowering movement of the support section 3 from the switching value 77 until the initial value is reached. The dynamic characteristic curve preferably comprises a second characteristic curve range, which is inactive during the lifting movement of the support section 3 from the initial value of the input variable until the switching value 77 is reached and is active during the lowering movement of the support section 3 from the switching value 77 until the initial value is reached. The initial value is, for example, an input variable equal to zero.

The dynamic characteristic curve comprises a first characteristic curve section 95, which extends to a lower increase interval limit 96, in particular starting from an input variable equal to zero. The first characteristic curve section 95 is expediently constant, for example equal to the first support force specification 67, in particular equal to zero. The dynamic characteristic curve further comprises a second characteristic curve section 97, which expediently adjoins the first characteristic curve section 95 in the direction of the increasing input variable. The second characteristic curve section 97 expediently provides the increase interval 93 and extends from the lower increase interval limit 96 to an upper increase interval limit 98. The second characteristic curve section 97 is expediently monotonically increasing, in particular strictly monotonically increasing, exemplarily linearly increasing. The dynamic characteristic curve further comprises a third characteristic curve section 99, which expediently adjoins the second characteristic curve section 97 in the direction of the increasing input variable. The third characteristic curve section 99 extends, by way of example, from the upper increase interval limit 98 to the switching value 77. The third characteristic curve section 99 is, by way of example, constant, for example equal to the second support force specification 68, in particular greater than zero. The first characteristic curve section 95, second characteristic curve section 97 and the third characteristic curve section 99 together form the first characteristic curve range.

The dynamic characteristic curve comprises a fourth characteristic curve section 101, which extends from the switching value 77 to an upper decrease interval limit 102. The fourth characteristic curve section 101 is expediently constant, for example equal to the second support force specification 68, in particular greater than zero. The dynamic characteristic curve further comprises a fifth characteristic curve section 103, which expediently adjoins the fourth characteristic curve section 101 in the direction of the decreasing input variable. The fifth characteristic curve section 103 expediently provides the decrease interval 94 and extends from the upper decrease interval limit 102 to a lower decrease interval limit 104. The fifth characteristic curve section 103 is expediently monotonically decreasing, in particular strictly monotonically decreasing, exemplarily linearly decreasing. The dynamic characteristic curve further comprises a sixth characteristic curve section 105, which expediently adjoins the fifth characteristic curve section 103 in the direction of the decreasing input variable. As an example, the sixth characteristic curve section 105 extends from the lower decrease interval limit 104 to an input variable equal to zero. The sixth characteristic curve section 105 is exemplarily constant, for example equal to the first support force specification 67, in particular equal to zero. The fourth characteristic curve section 101, fifth characteristic curve section 103 and the sixth characteristic curve section 105 together form the second characteristic curve range.

The characteristic curve sections 95, 97, 99, 101, 103, 105 can also be referred to as dynamic characteristic curve sections.

The length of the increase interval 93, the lower increase interval limit 96, the upper increase interval limit 98, the first support force specification 67, the second support force specification 68, the length of the decrease interval 94, the lower decrease interval limit 104 and/or the upper decrease interval limit 102 expediently represent configuration parameters of the dynamic characteristic.

The dynamic characteristic therefore comprises direction-dependent characteristic curve ranges. Preferably, different dynamic characteristics can be defined for different work processes, e.g. for lifting loads, lifting loads down or for alternating movements with an almost constant load (e.g. grinding high walls). The directional dependency can expediently be implemented on the basis of changes in the state of the support section 3 or the tool 30, e.g. by sensors arranged on/in the tool 30.

For example, the control device 7 includes a preset with a dynamic characteristic for support during recurring lifting and lowering of loads. When using this preset, the exoskeleton 20 determines a direction of an arm movement of the user by observing the change in angle of the support section 3 and supports the arm movement depending on the direction and/or releases the arm movement depending on the direction. For example, the exoskeleton 20 supports the lifting of a load, which is then set down at a location above head height. If the arm is lowered again after the load has been set down, the exoskeleton 20 detects a negative change in angle. As a result, the exoskeleton lowers the support force to zero in accordance with the course of the decrease interval when the angle falls below a certain level—for example, the lower decrease interval limit 104—so that the empty arm can be lowered without having to overcome the support force.

Preferably, the exoskeleton device comprises an input device, for example the operating element 14 and/or the mobile device 40, via which the determined support force specification can be scaled by the user in order to provide a scaled support force specification 106. The control device 7 is configured to set the support force in accordance with the scaled support force specification 106.

In FIG. 5, an exemplary scaled support force specification 106 of the increase interval characteristic 63 is shown as a dashed line. Expediently, one or more other preset characteristics may be scaled in correspondence thereto.

The scaled support force specification 106 is in particular proportional to the (non-scaled) support force specification. In particular, the scaled support force specification 106 has the same curve shape as the (non-scaled) support force specification. For example, the control device 7 calculates the scaled support force specification 106 by multiplying the (non-scaled) support force specification by a scaling factor.

Preferably, the user can determine the scaling by entering the scaling factor with the operating element 14 and/or the mobile device 40.

Optionally, the force level of the support force can be set exclusively via the operating element 14. In particular, the scaling of the support force specification can be set exclusively via the operating element 14.

The following section describes in more detail how to select the preset to be used for determining the support force specification.

By way of example, the exoskeleton device 10 comprises an input device, in particular the operating element 14 and/or the mobile device 40, via which a user can select one of the presets, in particular from several available presets. For example, the user can select one of the presets by pressing a button and/or a touch screen. In this way, the preset to be used can be selected manually. Preferably, the operating element 14 comprises a preset input element, for example a preset button, with which a preset can be selected, activated, deactivated and/or switched between presets.

Optionally, the control device 7 is designed to select the preset to be used from the available presets on the basis of location information, tool information, personal information and/or movement information, in particular to automatically select and/or automatically activate it.

In particular, the location information indicates a geographical location. For example, the control device 7 receives a GPS signal and calculates the location information on the basis of the GPS signal. Furthermore, the control device 7 can receive the location information from a workstation, for example a station on a production line, by means of a location signal transmitted at the workstation, in particular by the station. Based on the location information, the control device 7 selects a preset that matches the location indicated by the location information.

The tool information indicates a tool, for example tool 30. For example, the control device 7 receives the tool information from the tool 30 by means of a tool signal, for example in the case of a Bluetooth connection between the exoskeleton 20 and the tool 30. The control device 7 selects a preset that matches the tool displayed by the tool information on the basis of the tool information.

The personal information indicates a person. For example, the control device 7 receives the personal information by means of a personal signal sent in particular by the mobile device 40, for example a smartphone. Furthermore, the exoskeleton 20 can comprise an identification device, for example a fingerprint sensor and/or an image sensor, in order to determine the personal information. Based on the personal information, the control device 7 selects a preset that matches the person indicated by the personal information.

The movement information indicates a movement, in particular a movement pattern, of the exoskeleton 20, in particular of the support section 3, and/or of the tool 30. Optionally, the movement information indicates that a movement of the exoskeleton 20, in particular of the support section 3, correlates, in particular matches, a movement of the tool 30. For example, the control device 7 receives a tool movement signal from the tool 30 and determines the movement information on the basis of a movement of the exoskeleton 20 detected in particular by the sensor device 6 and the tool movement signal. Based on the movement information, the control device 7 selects a preset that matches the movement indicated by the movement information.

Optionally, the user can enter the location information, tool information, person information and/or movement information manually, for example via the mobile device 40 and/or the operating element 14.

In particular, the control device 7 is configured to select the preset to be used in response to a trigger event. The trigger event is, for example, the receipt or occurrence of location information, tool information, person information and/or movement information.

Optionally, the preset to be used can be selected in response to a combination of trigger events. The trigger events are expediently detected using suitable wireless communication methods, for example based on Bluetooth, RFID chips or QR codes.

The control device 7 is preferably configured so that at any time only one preset—the selected preset—is active and the others—the non-selected presets—are not active. The control device 7 determines the support force specification on the basis of the active preset.

Optionally, the control device 7 is configured in such a way that a respective preset can be selected for each support section 3A, 3B. In particular, a different preset can be selected for the first support section 3A than for the second support section 3B, in particular manually and/or automatically. For example, the control device 7 calculates a right support force specification for the first (right) support section 3A on the basis of a preset selected for the first (right) support section 3A and a left support force specification for the left support section 3B on the basis of a preset selected for the second (left) support section 3B.

The following section explains in more detail how one or more presets can be configured.

Preferably, the exoskeleton device 10 comprises a configuration device via which a user can configure a preset. Expediently, the configuration device can be used to select and/or customize one or more preset characteristics for a preset.

Preferably, the configuration device is designed as the mobile device 40, in particular as a smartphone. As an example, the configuration device is implemented separately from the exoskeleton 20. For example, one or more presets configured with the configuration device can be transmitted to the exoskeleton 20, in particular the control device 7, in particular wirelessly, for example by means of Bluetooth and/or WLAN and/or mobile radio.

Furthermore, the configuration device can be implemented in the exoskeleton 20, for example on the control device 7, and can be expediently operated via the operating element 14.

Preferably, the configuration device comprises a preset library in which several predefined presets are stored. The user can select one or more presets from the preset library, in particular for further configuration of the presets and/or for transmission to the exoskeleton 20, in particular the control device 7. In particular, one or more presets from the preset library can be loaded into a preset memory of the control device 7. Expediently, the presets that can be selected during operation as the preset to be used for determining the support force specification are stored in the preset memory.

Preferably, the configuration device enables manual adjustment of one or more configuration parameters of a preset, in particular one or more of the aforementioned configuration parameters.

Preferably, the configuration device comprises a preset characteristic library in which a plurality of preset characteristics are stored, in particular one or more of the preset characteristics explained above. Expediently, the configuration device enables selection of one or more preset characteristics to create a preset comprising the one or more preset characteristics. Expediently, the configuration device further enables manual adjustment of configuration parameters of one or more preset characteristics, in particular one or more of the aforementioned configuration parameters.

A configuration parameter is, for example, a position, in particular the pivot angle 47, of the support section 3 and can preferably be entered into the configuration device by the user by the user using the support section 3 to assume the position to be entered as the configuration parameter, in particular in a previously activated input mode, which can also be referred to as a live input mode. For example, the user can set the predetermined position 78 for the rest position and/or the lower increase interval limit 69 and/or the upper increase interval limit 71 in this manner.

Preferably, the configuration device, in particular the mobile device 40, is configured to display a graphical representation of the exoskeleton 20 and/or a user who has put on the exoskeleton 20. Expediently, the position of the support section of the graphical representation, in particular its pivot angle, can be changed by user input in order to thereby enter a configuration parameter.

Preferably, voice recognition, gesture recognition and/or integrated situation recognition can also be used to select a preset and/or configure a preset.

Optionally, a preset to be used can be transmitted from the tool 30 to the exoskeleton 20, in particular the control device 7, preferably wirelessly.

Optionally, presets can be shared with other users and/or obtained from the manufacturer, for example from a cloud server. For example, presets can be stored in an app installed on the mobile device 40, e.g. a cell phone or laptop, after configuration by the user and sent via a communication interface, e.g. Bluetooth, WIFI, LAN or e-mail, e.g. to other users.

Optionally, the exoskeleton device 10 has a working mode, in which the support force is provided according to a selected preset, and an adjustment mode, in which the preset, in particular a characteristic curve of the preset, can be adjusted. Expediently, the preset, in particular the characteristic curve of the preset, can only be adjusted in the adjustment mode. The adjustment mode can, for example, be activated by the user on the exoskeleton 20.

Optionally, the exoskeleton device 10 has a position sensor 38, in particular an acceleration sensor, for detecting a position of the exoskeleton 20, in particular of the base section 1, relative to gravity. The control device 7 is configured to shift a characteristic curve of a characteristic curve characteristic on the basis of the detected position, in particular with respect to the axis of the pivot angle 47. For example, the characteristic curve of a preset characteristic can be shifted by the angle of the position depending on the position of the upper body (bent forwards or backwards).

Optionally, a preset characteristic can further take into account at least one operating parameter, for example motor power and/or rotational speed, of the tool 30 used by the user and/or at least one utilization parameter, for example a movement and/or acceleration of the tool 30 relative to gravity or a support direction of the exoskeleton, as an input variable when determining the support force specification. In particular, the relationship between such an input variable and the support force specification can be set by the user, for example by adjusting a characteristic curve of the preset characteristic.

Optionally, one or more presets can have a respective safety threshold value for a speed and/or acceleration of the support section 3. The exoskeleton 20 is expediently configured to reduce and/or deactivate the support force if the safety threshold value is exceeded.

Optionally, the exoskeleton device 10 has a situation-dependent mode in which an automated adaptation of a support force characteristic curve takes place. In particular, the exoskeleton device 10 is configured to perform pattern recognition, which recognizes a work and/or task situation and assigns a predefined or learned preset to the recognized situation, in particular completely or segment by segment, and preferably automatically adjusts the support force characteristic curve within movements or a work situation.

In particular, the exoskeleton device 10 can be operated using the following method:

One of the at least two presets is selected, in particular manually or automatically. A first preset is selected as an example. Using the selected first preset, the control device 7 determines the support force specification as a function of the input variable. The control device 7 sets the support force on the basis of the determined support force specification. The exoskeleton 20 supports the user's body part, in particular the limb, with the set support force via the support section 3.

Optionally, a different preset, for example a second preset, of the at least two presets can also be selected in the method, in particular manually or automatically. Using the selected second preset, the control device 7 determines the support force specification as a function of the input variable. The control device 7 sets the support force on the basis of the determined support force specification. The exoskeleton 20 supports the user's body part, in particular the limb, with the set support force via the support section 3.

1. An exoskeleton device, comprising:
an exoskeleton having:
a base section for attachment to a body section of the human body,
a support section movably coupled to the base section for supporting a body part of the human body,
an actuator device acting on the support section for providing a support force for the body part,
wherein the exoskeleton device further comprises:
a control device which has at least two manually and/or automatically selectable presets, each of which has at least one preset characteristic which defines a support force specification as a function of at least one input variable, in particular a position of the support section,
whereby the at least two presets differ in their preset characteristics, and
wherein the control device is configured to determine, using a preset selected from the at least two presets, the support force specification as a function of the input variable and to set the support force on the basis of the support force specification.

2. The exoskeleton device according to claim 1, wherein the at least one preset characteristic comprises an increase interval characteristic which defines an increase interval with respect to the input variable, in which increase interval the support force specification increases continuously with increasing input variable.

3. The exoskeleton device according to claim 2, wherein the increase interval characteristic defines a predetermined curve shape for the increase of the support force specification in the increase interval.

4. The exoskeleton device according to claim 2, wherein the increase interval characteristic defines a substantially constant support force specification above and/or below the increase interval.

5. The exoskeleton device according to claim 1, wherein the input variable comprises the position of the support section, and the at least one preset characteristic comprises a rest position characteristic which defines a predetermined position of the support section as the rest position, in which rest position the support force specification increases to a rest position specification value in order to hold the body part, in particular the limb, in the rest position.

6. The exoskeleton device according to claim 5, wherein the rest position specification value specifies a support force that is at least large enough for gravitational compensation, so that a user of the exoskeleton device in the rest position does not have to apply any force to his body part supported by the support section in order to keep the body part in the rest position.

7. The exoskeleton device according to claim 5, wherein the rest position specification value is a local maximum of the support force specification, such that the support force specification immediately above and below the rest position is smaller than the rest position specification value.

8. The exoskeleton device according to claim 5, wherein in the rest position characteristic, the support force specification further depends on whether the support section is moved in a lifting direction or in a lowering direction.

9. The exoskeleton device according to claim 1, wherein the at least one preset characteristic further comprises a dynamic characteristic, wherein the relationship between the support force specification and the input variable depends on the direction of change of the input variable and/or on reaching at least one predetermined switching value of the input variable.

10. The exoskeleton device according to claim 9, wherein the dynamic characteristic defines at least a first change interval and a second change interval, in each of which the support force specification changes via the input variable, and a dependency is defined in the dynamic characteristic, such that, depending on the direction of change of the input variable and/or reaching the switching value, selectively the first change interval or the second change interval defines the relationship between the support force specification and the input variable.

11. The exoskeleton device according to claim 10, wherein the input variable is an angle of the support section, the first change interval is an increase interval in which the support force specification continuously increases as the angle increases, and the second change interval is a decrease interval in which the support force specification continuously decreases as the angle decreases, and wherein
the increase interval ends at a smaller angle than the decrease interval begins or
the increase interval ends at a larger angle than the decrease interval begins.

12. The exoskeleton device according to claim 10, wherein the dynamic characteristic defines at least one substantially constant support force specification outside the change intervals.

13. The exoskeleton device according to claim 1, further comprising an input device via which the determined support force specification can be scaled by a user in order to provide a scaled support force specification, wherein the control device is configured to set the support force in accordance with the scaled support force specification.

14. The exoskeleton device according to claim 1, further comprising an input device via which a user can select one of the presets.

15. The exoskeleton device according to claim 1, wherein the control device is configured to select the preset to be used from the existing presets on the basis of location information, tool information, person information and/or movement information.

16. The exoskeleton device according to claim 1, further comprising a configuration device, via which a user can configure a preset, wherein one or more preset characteristics for a preset can be selected and/or adapted with the configuration device.

17. The exoskeleton device according to claim 1, wherein the at least one input variable comprises the position of the support section, the position of the base section and/or a tool signal received from a tool.

18. A method of operating an exoskeleton device according to claim 1, comprising the steps of:
selecting one of at least two presets,
using the selected preset, determining the support force specification as a function of the input variable, and
setting the support force on the basis of the determined support force specification.

19. The method of claim 18, further comprising the steps of:
selecting a different preset of the at least two presets,
using the selected preset, determining the support force specification as a function of the input variable, and
setting the support force on the basis of the determined support force specification.

20. The exoskeleton device according to claim 1, wherein the base section is for attachment to the torso of the human body and/or the support section is for supporting an arm of the human body.

21. The exoskeleton device according to claim 5, wherein, in the rest position, the support force specification increases abruptly to the rest position specification value.

22. The exoskeleton device according to claim 8, wherein the rest position is provided when the support section is moved in the lowering direction and reaches the predetermined position and is not provided when the support section is moved in the lifting direction and reaches the predetermined position.
